(19) United States
(12) Patent Application Publication
(10) Pub. No.: US 2006/0145389 A1
(43) Pub. Date: Jul. 6, 2006

(54) Method and device for producing plastic profiles

(76) Inventors: Meinhard Schwaiger, Linz (AT); Rudiger Preinstorfer, Kirchdorf (AT); Martin Jirka, Kirchdorf (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/532,120

(22) PCT Filed: Oct. 23, 2003
(86) PCT No.: PCT/AT03/00320

§ 371 Date: Dec. 9, 2005

(30) Foreign Application Priority Data
Oct. 25, 2002 (AT) A 1623/2002

(51) Int. Cl. B29C 47/00

(52) U.S. Cl. 264/148; 425/326.1

(57) ABSTRACT

The invention relates to a method for producing plastic profiles. According to said method, at least two extruded profiles (20.1, 20.2) are produced simultaneously, each of said extruded profiles (20.1, 20.2) is then quenched and calibrated in at least one calibration instrument (13.1, 13.2; 23.1, 23.2; 33.1, 33.2), the essentially cooled profiles being conveyed by a caterpillar take-off unit (4) and the profiles are finally processed into profile sections in a separation device (6.1, 6.2). To improve the performance and increase the flexibility of said method, the two extruded profiles (20.1, 20.2) are calibrated in a first operating mode in separate calibration instruments (13.1, 13.2; 23.1, 23.2; 33.1, 33.2), the take-off speeds for the two extruded profiles (20.1, 20.2) being preferably set independently of one another and in a second operating mode a single extruded profile (20) is produced. The invention also relates to devices for carrying out said method.

The invention relates to a method for producing plastic profiles, in which at least two streams of profiles are extruded simultaneously, whereupon each profile stream is cooled and calibrated in at least one calibrating device, and the essentially cooled profiles are taken off by a caterpillar pulling device and finally sized to profile sections by a cutting device.

In order to increase productivity in the manufacturing of plastic profiles used for window frames or similar objects, various efforts have been made to increase the extrusion speed. At higher extrusion speeds meeting the desired quality criteria becomes more and more difficult, however, thus limiting the extrusion speeds attainable in a cost-effective manner.

A known method of increasing the production capacity of a production line is to simultaneously extrude two profiles having small dimensions. The method employs a single extruder with an extruder die head which has two separate orifices for the two profile streams. The calibrating devices, that is the dry calibrators and calibrating tanks, are also designed to simultaneously process two parallel profile streams. The two profile streams are pulled through the calibrating devices by a common caterpillar puller and are further conveyed to a cutting device, which may be configured as a saw or a knife cutter, i.e. a so-called guillotine. The cutting device will for instance produce profile sections with a length of six meters from which the required profile pieces may then be cut.

Although a double-stream extrusion device of this type should theoretically double the capacity of a production line, the rigid connection between the two extrusion processes will in practice be accompanied by certain problems. It is for instance disadvantageous that a manipulation required in the process of one profile stream will in many cases also influence the production process of the other profile stream. If the extrusion line must be shut down because of problems with one stream, production of the other stream will also come to a standstill and restarting the process will produce detectives on both streams until the process for both streams has been stabilized again. Besides, it will only be possible to produce identical or closely similar profiles on the two streams because operational difficulties would otherwise soon become intractable.

As a solution to these problems WO 96/29186 A has proposed the use of two independent caterpillar take-off devices with a double-stream extruder, enabling each stream to be run at its optimum extrusion speed. Practice has shown, however, that in the case of an incident in one extrusion stream most manipulations in the affected stream will still exert a disadvantageous influence on the extrusion process of the other stream.

A further disadvantage of this known solution lies in start-up problems of the production line, since two profile streams must simultaneously be guided through the extrusion heads and then lifted in order to permit the vacuum in the dry calibrators to be built up.

A further problem in this context lies in the fact that a production line for double-stream extrusion is suitable only for the production of relatively small profiles, since the profile dimensions possible in simultaneous production with two profile streams are limited by the very nature of the process. Flexibility of a production line of this type thus is limited and practical applicability reduced.

A further known solution is described in U.S. Pat. No. 5,238,165 A, where a flexible caterpillar take-off device is shown. Regarding independence of multiple extrusion processes, no advantageous solution is offered.

It is an object of the present invention to avoid the disadvantages mentioned and to propose a method which permits simultaneous production of two profile streams, but is operationally simpler and produces a lower number of defectives, while permitting more flexibility in production planning and better utilization of machinery. A further aim of the invention is to describe apparatus for the implementation of the method.

Another aim of the invention is to propose a method and apparatus permitting the production of profiles of particularly large dimensions.

It is proposed by the invention that in the production of plastic profiles one group of calibrator tools for a first profile stream can be shifted in longitudinal direction independently of the calibrator tool group for the second profile stream.

The process is implemented in such a way that in a first operational mode the two profile streams are calibrated in separate calibrator units, the take-off speeds preferably being individually adjustable for each of the profile streams, and that in a second operational mode production of a single profile stream is possible.

The basic idea of the present invention lies in the decoupling of the production processes, which permits each of the profile streams to be produced in the best possible way. An essential condition for this is that the take-off speeds of the two profile streams are independent of each other. This may be carried to the point that the extrusion process of one extrusion line may be shut down completely if problems of tool changing or the like occur, without influencing or in any way affecting the production process of the other profile stream. Due to the fact that the calibrator tool groups of the profile streams may be shifted in longitudinal direction, manipulations and adjustments of one stream may be carried out without disturbing the extrusion process of the other stream.

This will also enable the production of profiles of large dimensions without costly adaptation efforts.

In principle it is possible to produce both profile streams on a common extruder. Such a common extruder may for instance be furnished with two separate extrusion tools, i.e. extrusion nozzles, or a common extrusion tool with two orifices. In order to realise differing extrusion speeds such an extruder should be provided with a distributing device for distributing the mass flow of molten plastic toward the two extrusion orifices at a ratio to be chosen.

In a preferred variant the two profile streams are provided by two independent extruder units. In this way complete independence of the production process of the profile streams will be achieved.

In order to realise the desired increase in productivity for given exterior dimensions of an extruder line it is particularly preferable to calibrate the two profile streams in calibrator tool units which are located on a common calibrator table. This common calibrator table whose substructure is essentially like that of a conventional calibrator table, carries the usual assemblies for water supply and drainage and for vacuum generation. But it also carries two independent mounting stations for the calibrator tool units proper.

The present invention designates as calibrator tool units dry calibrators as well as calibrating tanks. Calibrating tanks are usually designed as vacuum tanks in which the profile is passed through appropriate calibrating apertures, with the vacuum of the tank causing the profile to fit tightly against the aperture. A turbulent flow of cooling water, which passes in the longitudinal direction of the tank through openings in the walls carrying the apertures, provides for rapid cooling and solidification of the profile stream, as required to achieve satisfactory performance of the product. The individual calibrator tool units may be positioned on separate mounting stations which are placed one behind the other in longitudinal direction, or they may be located on a common mounting station,

Furthermore it is preferably provided that the two profile streams are pulled in a first operational mode by a common caterpillar belt puller having two independently driven belt pairs, and that in a second operational mode the single profile stream is jointly moved by both belt pairs. The take-off speed of the caterpillar belt puller defines the extrusion speed, which in turn is the essential parameter for the attainable productivity and quality of the profile.

In order to be able to produce profile sections of customary length even in the case of differing extrusion speeds, it is preferentially proposed that the two profile streams be cut into profile sections by a cutting unit having at least two independently movable saws or knives. In this way it is possible to produce for instance 6-meter rods, which after intermediate storage and the end of the shrinking process may be worked into profile sections of exact dimensions. It will also be possible, however, to produce such profile sections in-line, by using the cutting unit to perform accurately dimensioned mitre cuts with the expected shrinkage being taken into account in the computing of dimensions.

The flexibility of the process according to the invention may be especially increased by optionally producing either two profile streams in parallel or one single profile stream only. By proper design of the individual components of the assembly it is possible to produce, instead of two smaller profiles, a single profile with small or larger dimensions, thus opening a particularly large range of applications for an extrusion line as proposed by the invention.

The invention furthermore relates to a device for the cooling and calibrating of plastic profiles in a process as described above, with a calibrator table carrying at least one tool mounting station.

According to the invention such a device is characterised in that the calibrator table carries at least two mounting stations on which the calibrator tool groups may be detachably mounted and which can be moved independently of each other in longitudinal and preferably in transversal direction. In order to permit the required manipulations on the extruder line it is necessary that the extrusion tools are moveable relative to the extruder proper in longitudinal direction. This is usually achieved by making the calibrator table as a whole moveable in the direction of the extruder stream. The calibrator assembly according to the invention may also provide for such a calibrator table which is moveable in longitudinal direction. But in addition to this the two mounting stations will be moveable at least in longitudinal direction, in order to enable manipulating the calibrator tools of one profile stream without disturbing the production process of the other profile stream. Preferentially there is also moveability in trans-versal direction, permitting the distance between the two profile streams to be adjusted to suit the given situation. A calibrator tool group as referred to above is to be understood as the ensemble of dry calibrators and calibrating tanks, with the individual components selected in a known way in accordance with the profile to be produced.

In a particularly preferred variant of the above device it is provided that the mounting stations be configured such that they can carry at least one dry calibrator and at least one calibrating tank. A configuration of this kind, where a single mounting station carries all necessary calibrating tools, permits calibration to be performed in a particularly simple and robust way. Furthermore it is possible to simultaneously remove all tools in a single tool exchange step and, in a similar way, to set up new tools in a single step.

Special advantages as regards independent process control can be achieved by providing independently controlled vacuum connections for both calibrating tool groups. Besides, it is particularly favourable if independently controlled water supply lines are provided for both calibrating tool groups. In particular this will permit the simultaneous production of different profiles.

As mentioned above the flexibility of an extrusion line according to the invention may be enhanced especially by providing that the two mounting stations can be connected in such a way that a single calibrator tool group can be detachably mounted.

The present invention also relates to a take-off device for plastic profiles, which is configured as a caterpillar belt puller with two parallel pairs of caterpillar belts provided side by side.

A device of this sort according to the invention is characterised in that the caterpillar belt pairs are moveable independently of each other, thus enabling them either to pull one of two profile streams each, or a single profile stream together.

In a particularly preferred variant of the said device a separating wall, which preferably is removable, is provided between the two caterpillar belt pairs. For reasons of operator safety a caterpillar belt puller must always be designed with a cover, which in the closed state eliminates the danger of the operator's hands getting caught. Suitable safety circuits must guarantee that opening of the cover causes immediate standstill of the belt pair, forestalling accidents. In the caterpillar belt puller according to the invention two pairs of caterpillar belts are provided, which can each be accessed from both sides by opening a cover. In order to avoid unnecessary disturbance of the respective other production process the opening of a cover causes only the standstill of the belt pair immediately beneath the cover. The separating wall referred to above is provided to eliminate any possibility of manual contact with the other belt pair, which theoretically could occur. The separating wall is preferably removable, however, so that the belt pairs can be connected if a single profile stream is to be pulled. In this case there will be no danger for the operator since the opening of a single cover will cause both belt pairs to stand still. The connection between the belt pairs may be achieved by mechanical coupling or by suitable electronic control of the drive mechanism.

The invention further relates to a cutting device for plastic profiles comprising a base body on which at least one cutting tool is moveable in longitudinal direction.

The invention proposes at least two cutting tools which can be moved independently of each other.

In an essentially known manner the cutting tools may be configured as saws or as knives, i.e. so-called guillotines, which cut profile sections cleanly without shavings. It is essential that the two cutting tools be moveable independently of each other, such that each profile stream may be cut into profile sections of any desired length.

The length of an extrusion line is limited in general. In order to avoid floor-space problems it is proposed in a particularly preferred variant that two cutting tools be placed side by side.

If the extrusion line is also to be employed for the production of a single profile stream of a certain width, it is especially preferable if in addition to two independently moveable cutting tools, a third cutting tool is placed upstream or downstream thereof. In this case the two independently moveable cutting tools are left idle and the single profile stream is cut by the third cutting tool.

Since in any case either the two independently moveable cutting tools or the third cutting tool alone will be used, but never all three tools together, they may be placed on a common base body, with the paths of the cutting tools overlapping. This will result in a particular economy of space.

In the following the present invention will be described in more detail with reference to the embodiments shown in the drawings, where

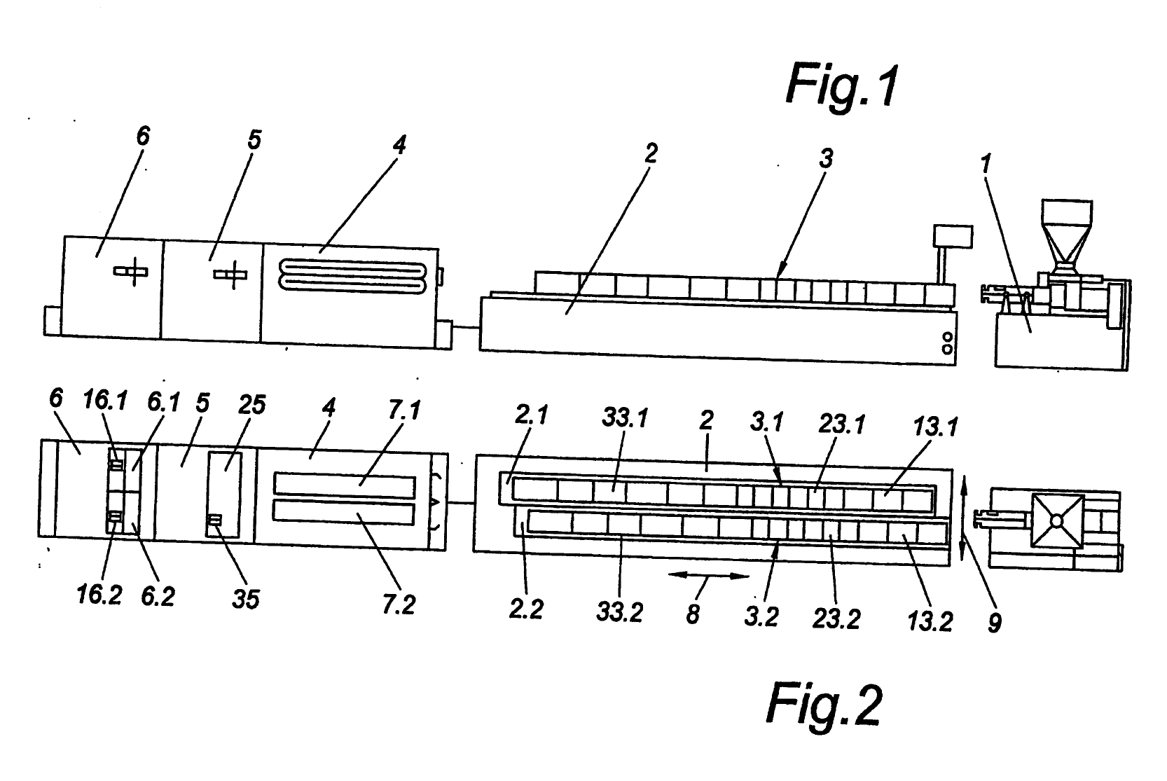

FIG. 1 shows a side view of an extrusion line according to the invention;

FIG. 2 shows the extrusion line of FIG. 1 in plan view;

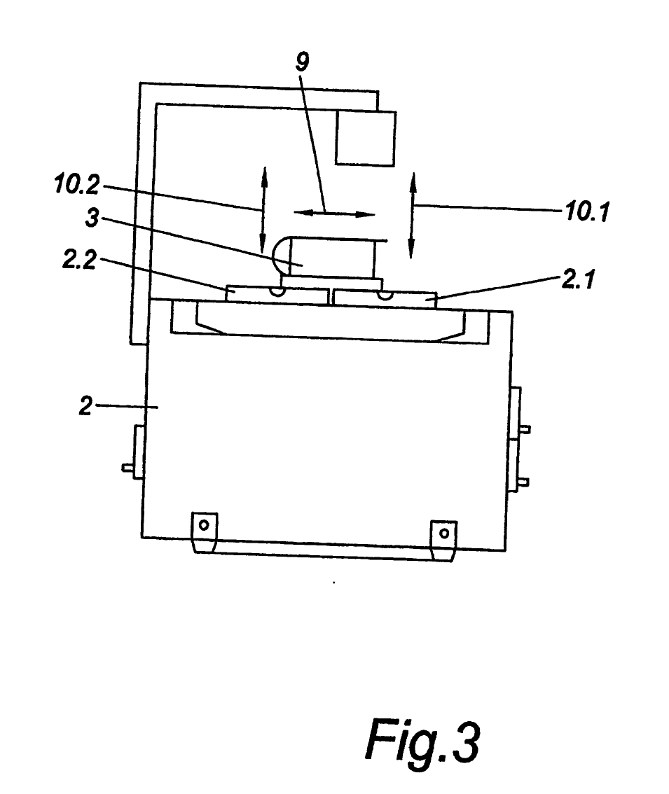

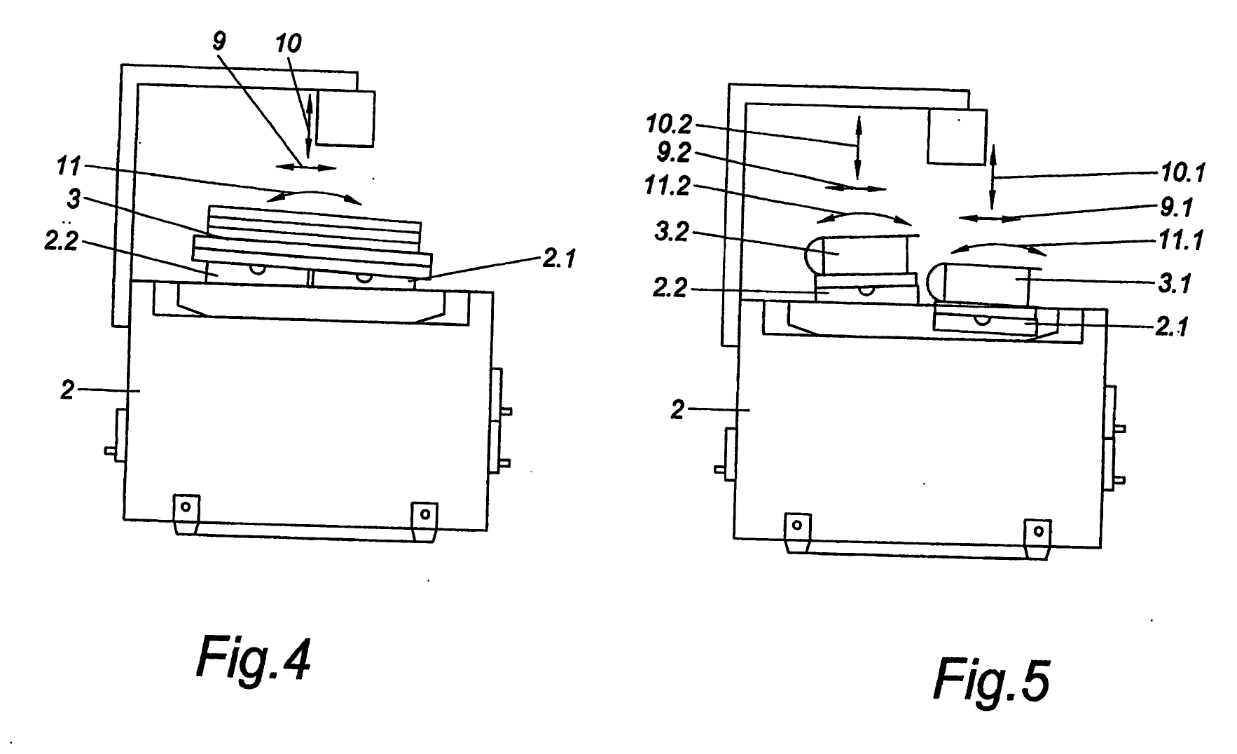

FIG. 3, FIG. 4, FIG. 5 each show a section through a device for the cooling and calibrating of profiles in different operational states;

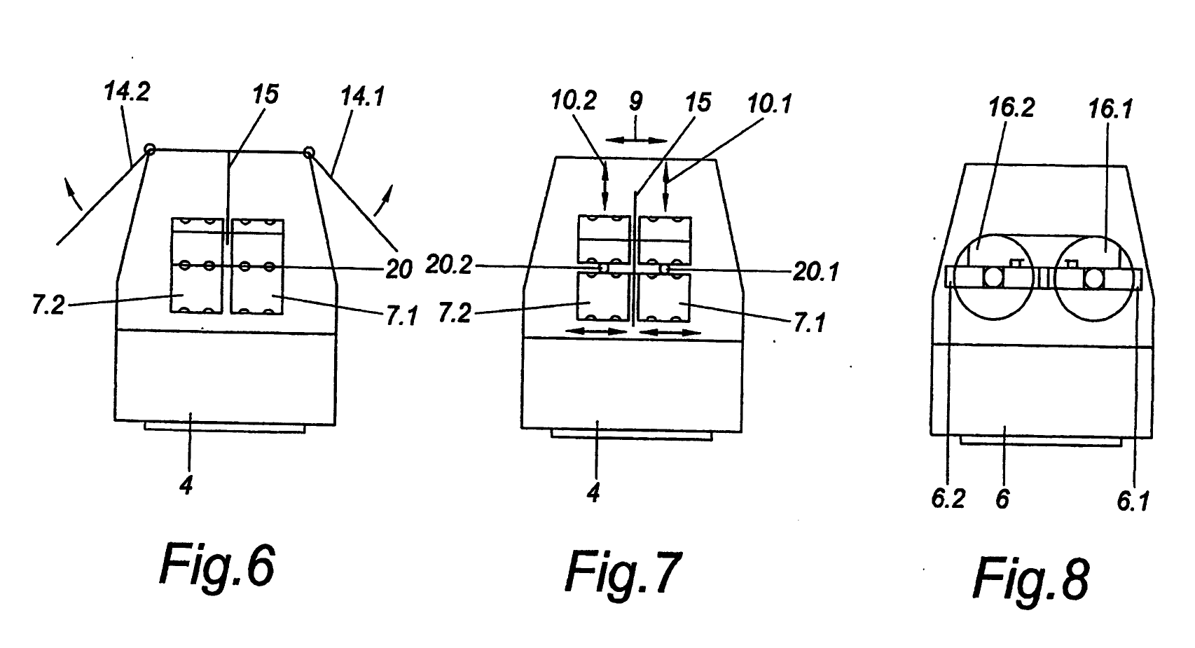

FIG. 6 and FIG. 7 show a sectional view of a pulling device for plastic profiles according to the invention in different operational states;

FIG. 8 shows a section through a profile saw.

The extrusion line of FIGS. 1 and 2 comprises an extruder 1, a calibrator table 2 carrying a single calibrating tool 3 or two calibrator groups 3.1 and 3.2, a caterpillar belt puller 4, a first cutting device 35 and a second cutting device configured as two units 6.1 and 6.2.

FIG. 2 shows that the calibrator table 2 carries two independently moveable mounting stations 2.1 and 2.2, each holding a separate calibrator tool group 3.1 and 3.2. The calibrator tool groups 3.1, 3.2 comprise dry calibrators 13.1, 13.2, upstream calibrating tanks 23.1, 23.2, and downstream calibrating tanks 33.1, 33.2. The mounting stations 2.1, 2.2 may be moved, each independently of the other, in longitudinal direction, as indicated by the double arrow 8, as well as in transversal direction, indicated by the double arrow 9.

From FIG. 3 it can be seen that the two mounting stations 2.1, 2.2 may be coupled with each other, in order to jointly support a single calibrator tool group 3 for calibration of an ordinary profile. The figure also shows that the two mounting stations 2.1, 2.2, besides being transversally moveable as indicated by double arrow 9, may also be height-adjusted in the direction of the double arrows 10.1, 10.2, each independently of the other.

The variant shown in FIG. 4 is similar to that of FIG. 1, the difference being that the mounting stations 2.1, 2.2 carry a tool group 3 suitable for a profile of particularly large dimensions. To permit the necessary adjustments the unit made up of the connected mounting stations 2.1, 2.2 may be tilted as a whole about the profile axis as indicated by the double arrow 11. The possibility of height adjustment is shown by the common double arrow 10.

In the variant of FIG. 5 the mounting stations 2.1, 2.2 carry separate calibrator tool groups 3.1, 3.2. These are laterally moveable, height-adjustable, and tiltable about the profile axis, each independently of the other, as indicated by the double arrows 9.1, 9.2; 10.1, 10.2; 11.1, 11.2.

The assemblies for water supply and drainage and for vacuum generation are housed in the calibrator table 2 in a known way, with independent controls realised for each of the two calibrator tool groups 3.1, 3.2.

FIG. 6 shows a section through a caterpillar belt puller 4 with two separately controllable belt pairs 7.1, 7.2 placed side by side. The caterpillar belt puller 4 has two covers 14.1, 14.2, which may be opened to permit access to the belt pairs 7.1, 7.2. In the variant of FIG. 6 the belt pairs 7.1, 7.2 are coupled together in order to pull a single profile stream 20 of large exterior dimensions. A separation wall 15 is in its lifted position so as not to collide with the profile stream 20. Since the belt pairs 7.1, 7.2 are coupled to move jointly it is guaranteed that opening one of the covers 14.1, 14.2 will cause standstill of both belt pairs 7.1, 7.2, thus eliminating danger for the operating personnel.

FIG. 7 shows the caterpillar belt puller 4 in an application where the belt pairs 7.1, 7.2 are employed in the production of separate profile streams 20.1, 20.2, each acting independently of the other. In this operational mode the separation wall 15 is lowered between the belt pairs 7.1, 7.2, thus making operator access to a possibly moving belt pair 7.1, 7.2 across a non-moving belt pair 7.2, 7.1 impossible.

FIG. 8 shows a device for the cutting of plastic profiles comprising a base body 6 and two cutting tools 6.1, 6.2 which are moveable in longitudinal direction independently of each other, each with a saw 16.1, 16.2. The two profile streams 20.1, 20.2 may thus be cut independently of one another. Upstream of the cutting unit depicted in FIG. 8 a conventional cutter is provided, which has a cutting unit 25 with a saw 35 carried on a base body 5, either for the simultaneous cutting of two profile streams 20.1, 20.2 or for the cutting of a single profile stream 20.

The present invention permits doubling the production performance of an extrusion line, at comparable occupied floor space, without incurring the disadvantages of a rigid coupling of two separate extrusion processes. A further advantage of the invention lies in the increased flexibility regarding product dimensions.

1-20. (canceled)

21. A method for the producing of plastic profiles, in which at least two profile streams are extruded simultaneously, whereupon each profile stream is cooled and calibrated in at least one calibrating device, and the essentially cooled profile streams are taken off by a caterpillar pulling device and are finally sized to profile sections by a cutting device, wherein in the production of plastic profiles one group of calibrator tools for a first profile stream is shifted in longitudinal direction independently of the calibrator tool group for the second profile stream.

22. A method according to claim 21, wherein the two profile streams are made by two independent extruder units.

23. A method according to claim 21, wherein the two profile streams are cut into profile sections by a cutting tool comprising at least two saws or knives that are moveable independently of each other.

24. A device for the cooling and calibrating of plastic profiles with a calibrator table carrying at least two tool mounting stations on which the calibrator tool groups can be detachably mounted, which tool mounting stations can be moved independently of each other in longitudinal and preferably in transversal direction, and can either hold a separate calibrator tool group each or may be coupled in order to jointly support a single calibrator tool group.

25. A device according to claim 24, wherein the tool mounting stations are height-adjustable about their longitudinal axes, each independently of the other.

26. A device according to claim 24, wherein the tool mounting stations are tiltable about their longitudinal axes, each independently of the other.

27. A device according to claim 24, wherein the two tool mounting stations in their coupled state can be jointly moved in longitudinal direction, in transversal direction and in vertical direction, and can be tilted about a longitudinal axis.

28. A device according to claim 24, wherein the tool mounting stations are configured so as to hold at least one dry calibrator unit and at least one calibrating tank.

29. A device according to claim 24, wherein the calibrator table as a whole is moveable in longitudinal direction.

30. A device according to claim 24, wherein independently controlled vacuum connections are provided for the two calibrating tool groups.

31. A device according to claim 24, wherein independently controlled water supply lines are provided for both calibrating tool groups.

32. A take-off device for plastic profiles which is configured as a caterpillar belt puller with two parallel pairs of caterpillar belts provided side by side, said caterpillar belt pairs being moveable independently of each other, so that each of them will be able to pull off one of two profile streams, or both together a single profile stream.

33. A device according to claim 32, wherein a preferably removable separating wall is provided between the two caterpillar belt pairs.

34. A device according to claim 33, wherein the caterpillar belt pairs can be connected if a single profile stream is to be pulled.

35. A device according to claim 32, wherein the distance between the middle axes of the two caterpillar belt pairs is adjustable.

36. A cutting device for plastic profiles comprising a base body on which two cutting tools which are moveable in longitudinal direction independently of each other are provided.

37. A device according to claim 36, wherein two cutting tools are placed side by side.

38. A device according to claim 36, wherein a third cutting tool is provided upstream or downstream of two independently moveable cutting tools.

39. A device according to claim 38, wherein the longitudinal movement paths of the two separately moveable cutting tools and the third cutting device will overlap.

40. A device according to claim 36, wherein the cutting tools are configured as saws.

41. A device according to claim 36, wherein the cutting tools are configured as knives.
